(19) United States
(12) Patent Application Publication
(10) Pub. No.: US 2004/0119773 A1
(43) Pub. Date: Jun. 24, 2004

(54) Ink jet head and ink jet printer

(76) Inventor: Masato Ueda, Tokyo (JP)

Correspondence Address: Cameron K. Kerrigan, Squire, Sanders & Dempsey L.L.P., Suite 300, 1 Maritime Plaza, San Francisco, CA, 94111, US

(21) Appl. No.: 10/648,534

(22) Filed: Aug. 25, 2003

(30) Foreign Application Priority Data
Aug. 30, 2002 (JP) 2002-256055

(51) Int. Cl. B41J 2/015

(52) U.S. Cl. 347/20

(57) ABSTRACT

An ink jet head having: a nozzle tip having a front end surface in which a nozzle for jetting ink is provided, and four side surfaces adjacent to a back end surface which is opposite to the nozzle; and a frame shape member on which the nozzle tip is mounted, the frame shape member having a first protrusion pair each of which abuts on one pair of facing sides of the four side surfaces to sandwich the nozzle tip, and a second protrusion pair which abuts on the other pair of facing sides of the four side surfaces to sandwich the nozzle tip.

### BACKGROUND OF THE INVENTION

1. Field of the Invention

The present invention relates to an ink jet head and an ink jet printer.

2. Description of the Related Art

An ink jet printer jetting ink on a recording medium such as a sheet, a plastic thin plate or the like to record a predetermined image has been proposed and been in practical use. The ink jet printer comprises an ink jet head having a nozzle (ink jetting opening), the ink jet printer jets ink from the nozzle toward a recording medium while moving the ink jet head in a predetermined direction to record a predetermined image on the recording medium.

For example, Japanese Patent Laid-open Application No. 2002-46256 discloses such ink jet head.

FIG. 8 is an exploded perspective view for explaining a structure of a portion near a nozzle of an ink jet head according to an earlier technique developed by the applicant of the present invention. As shown in FIG. 8, the portion in the vicinity of the nozzle comprises a frame 110, a nozzle tip 120, a flexible wiring substrate 130 and the like.

The frame 110 is fixed in a state properly positioned to have a predetermined positioning relation to a carriage which is not shown in the figure, and moves together with the carriage in a predetermined direction. The frame 110 is fixed in a state positioned to the carriage so that displacement of an ink jetting position can be prevented. Further, in the frame 110, an opening 111 for fixing the nozzle tip 120 is formed.

The nozzle tip 120 is a thin plate shape member as shown in FIG. 8, and comprises a nozzle at a front end portion 121 with openings for jetting ink. The portion near the front end portion 121 of the nozzle tip 120 is inserted to the opening 111 of the frame 110 to be fixed to the frame 110.

To prevent displacement of the ink jetting position and to form a high quality image, it is required to fix the nozzle tip 120 in a state properly positioned to have a predetermined positional relation to the frame 110.

In the earlier technique, the following method is adopted to carry out a positioning of the nozzle tip 120. The inner shape of the opening 111 of the frame 110 is formed a slightly larger than the outer shape of the front end portion 121, and protrusions 113 are provided at short sides of the inner shape 112 of the opening 111 of the frame 110. The positioning is carried out based on only one of the protrusions 113 and one of the long sides of the inner shape 114. A long side surface 122 of the front end portion 121 of the nozzle tip 120 is abutted on one of the long side of the inner shape 114 of the opening 111 in the frame 110 in a state pressing to the long side of the inner shape 114 and is adhered to be fixed.

However, when the above-mentioned positioning is adopted, the positioning accuracy is relatively low because the positioning of the nozzle tip 120 is carried out by adjusting the position of the nozzle tip 120 based on only one of the protrusions 113 and one of the long sides of the inner shape 114.

Generally, the frame 110 is made of metal material such as aluminum or the like by die-casting. However, in the above-described positioning in the earlier technique, it is required to form the protrusions 113 on the short sides of the inner shape 112 of the opening 111 in the frame 110 by cutting process. Moreover, fine adjustment is required by performing cutting process in a wide area of the long sides of the inner shape 114. This results in requiring a lot of time and large costs for cutting process.

### SUMMARY OF THE INVENTION

An object of the invention is to improve the positioning accuracy of a nozzle tip to a frame, and to reduce the time and cost for cutting process of the frame in an ink jet head.

Another object of the invention is to provide an ink jet printer having the above-mentioned ink jet head.

In accordance with a first aspect of the present invention, the ink jet head comprises:

a nozzle tip comprising a front end surface in which a nozzle for jetting ink is provided, and four side surfaces adjacent to a back end surface which is opposite to the nozzle; and

a frame shape member on which the nozzle tip is mounted, the frame shape member comprising a first protrusion pair which abuts on one pair of facing sides of the four side surfaces to sandwich the nozzle tip, and a second protrusion pair which abuts on the other pair of facing sides of the four side surfaces to sandwich the nozzle tip.

According to the ink jet head, the first protrusion pair abuts on the one pair of facing sides of the four side surfaces of the nozzle tip to sandwich the nozzle tip, and the second protrusion pair abuts on the other pair of facing sides of the four side surfaces of the nozzle tip to sandwich the nozzle tip. Thus the nozzle tip can be positioned properly to the frame shape member in a horizontal direction.

In addition, according to the ink jet head, since the nozzle tip can be positioned properly only by forming the first protrusion pair and the second protrusion pair by carrying out cutting process on the frame shape member, it is unnecessary to carry out cutting process in wide area on the frame shape member as the earlier technique. Accordingly, the time and cost for cutting process are extremely reduced.

In accordance with a second aspect of the present invention, the ink jet printer comprises:

an ink jet head which comprises a nozzle tip comprising a front end surface in which a nozzle for jetting ink is provided and four side surfaces adjacent to a back end surface which is opposite to the nozzle, and a frame shape member comprising a first protrusion pair which abuts on one pair of facing sides of the four side surfaces to sandwich the nozzle tip and a second protrusion pair which abuts on the other pair of facing sides of the four side surfaces to sandwich the nozzle tip, for mounting the nozzle tip; and

a carriage on which the ink jet head is mounted in a state pre-positioned.

According to the ink jet printer, since the ink jet head is mounted to the carriage in a state pre-positioned, the relative position relation of the nozzle tip to the carriage can be fixed. Thus, displacement of the ink jetting position can be prevented and an image with a high accuracy can be formed.

Preferably, in the ink jet head or the ink jet printer, the nozzle tip comprises an electrode terminal on a central portion of the one pair of facing sides, and the first protrusion pair abuts on a portion of the one pair of facing sides on which no electrode terminal is provided to sandwich the nozzle tip.

The central portion means a certain region which includes the center of the one pair of facing sides.

According to the structure, since the first protrusion pair abuts on a portion of the one pair of facing sides on which no electrode terminal is provided to sandwich the nozzle tip, the nozzle tip can be positioned to the frame shape member more properly, and this allows other members to be connected to the electrode terminal.

Preferably, the frame shape member comprises an abutment portion on which the back end surface of the nozzle tip abuts.

According to the structure, since the frame shape member comprises the abutment portion on which the back end surface of the nozzle tip abuts, the nozzle tip can be positioned properly to the frame shape member in a vertical direction.

Preferably, the frame shape member comprises a first protrusion member and a second protrusion member on inner walls of both ends of the frame shape member, respectively, so as to face each other, the first protrusion member comprising the first protrusion pair and one protrusion of the second protrusion pair, the second protrusion member comprising the first protrusion pair and the other protrusion of the second protrusion pair.

Preferably, each of the first protrusion member and the second protrusion member further comprises an abutment portion on which the back end surface of the nozzle tip abuts.

Preferably, the first protrusion pair is arranged on the abutment portion perpendicularly.

Preferably, the second protrusion pair is arranged on the abutment portion perpendicularly

Preferably, the frame shape member is made of at least one selected from aluminum, resin, magnesium and silver.

Preferably, the frame shape member is formed as one body by die-casting.

Preferably, the first protrusion pair and the second protrusion pair are formed by cutting process.

Preferably, the nozzle tip has a thin plate shape.

Preferably, the back end surface of the nozzle tip has a uniform width.

The uniform width is not limited to the proper sense of the word. Thus, the back end surface of the nozzle tip may have an approximately uniform width.

Preferably, a width of the back end surface of the nozzle tip is smaller than a width of the front end surface.

Preferably, a piezoelectric element of shear mode type is built in the ink jet head.

According to the structure, the outer shape and the back end surface of the nozzle tip can be formed at a time of forming a groove, so that the positioning accuracy of the nozzle tip to a housing frame can be improved.

### BRIEF DESCRIPTION OF THE DRAWINGS

The present invention will become more fully understood from the detailed description given hereinafter and the accompanying drawings which are given by way of illustration only, and thus are not intended as a definition of the limits of the present invention, and wherein;

FIG. 1 is a schematic view for explaining an ink jet printer according to the first embodiment of the present invention;

FIG. 2 is an exploded perspective view of the ink jet head according to the first embodiment of the present invention;

FIG. 3 is an exploded perspective view of the ink jet head shown in FIG. 2 seen from the direction of the arrow III;

FIG. 4 is an enlarged perspective view showing the housing frame which forms the ink jet head and the nozzle tip before being fixed to the housing frame according to the first embodiment of the present invention;

FIG. 5 is an enlarged perspective view showing the state in which a nozzle tip is fixed to a housing frame which forms the ink jet head according to the first embodiment of the present invention;

FIG. 6A is a view of the housing frame and the nozzle tip shown in FIG. 5 seen from the direction of the arrow VI, and FIG. 6B is an enlarged view of the B portion in FIG. 6A;

FIG. 7A is a view showing the housing frame which forms the ink jet head and the nozzle tip fixed to the housing frame seen from below according to the second embodiment of the present invention, and FIG. 7B is an enlarged view of the B portion shown in FIG. 7A; and

FIG. 8 is an exploded perspective view for explaining a portion of the structure of an ink jet head according to an earlier technique developed by the applicant of the present invention.

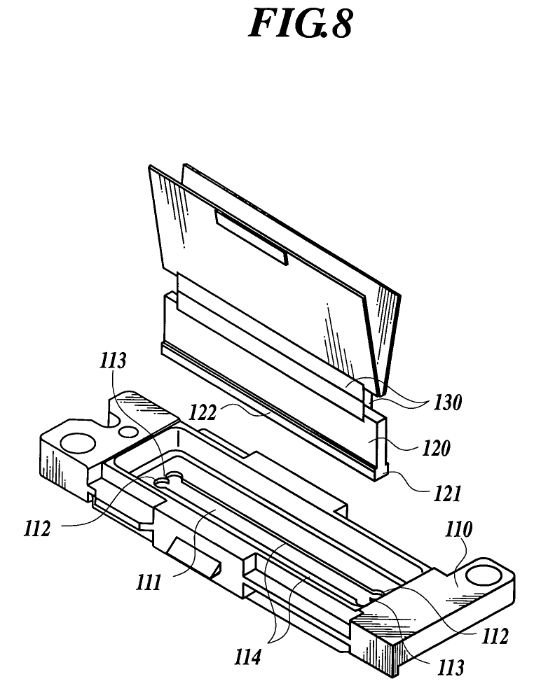

### DETAILED DESCRIPTION OF THE PREFERRED EMBODIMENTS

Hereinafter, the preferred embodiments of the present invention will be described in detail by reference to the attached drawings.

First Embodiment

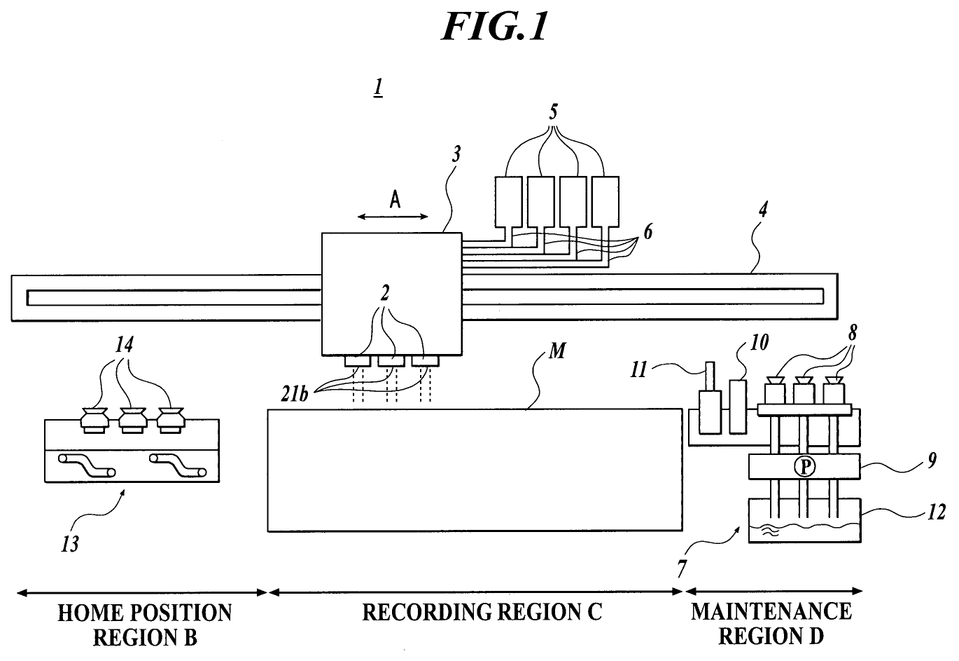

A structure of an ink jet printer 1 according to the present embodiment will be described referring to FIG. 1. FIG. 1 is a schematic view for explaining the structure of the ink jet printer 1 according to the embodiment. As shown in FIG. 1, the ink jet printer 1 comprises a ink jet head 2, a carriage 3, a carriage rail 4, an ink tank 5, an ink supply tube 6, a maintenance unit 7, a moisture retaining unit 13 and the like. The ink jet printer 1 jets ink to a predetermined recording medium M to form a predetermined image on the recording medium M.

The recording medium M on which an image is formed by the ink jet printer 1 is adapted to pass through a recording region C in FIG. 1, and is carried by a carrying section (not shown) in a sub scanning direction which is perpendicular to the direction of an arrow A (hereinafter referred to as a “main scanning direction”) in FIG. 1.

The ink jet head 2 comprises a nozzle for jetting ink. An image is formed on the recording medium M by jetting ink in tandem with the scanning of the carriage 3 by reciprocating movement in the recording region C. The ink jet head 2 is mounted to the carriage 3 in a state that a nozzle side surface 21b (described below) on which nozzles for jetting ink are arranged in parallel is disposed to face the recording medium M.

In the embodiment, a piezoelectric element of shear mode type is built in the ink jet head 2.

In an ink jet head of the shear mode type, grooves are mechanically formed on PZT (piezoelectric) substrate made of a piezoelectric material by using a dicing saw or the like to form an actuator by a channel and a channel wall. A cover plate is attached on an upper surface of the actuator, and a nozzle plate is attached on a front surface of the actuator, respectively. Then, ink is filled in the channel. Voltage is applied to a driving electrode which is formed on both surface of the actuator, so that shearing stress is generated so as to transform the actuator in a direction in which volume of the channel shrinks. Thus, an inner pressure increases and ink is jetted from a nozzle as droplets.

The ink jet head 2 can be placed in vertical position for use to make the ink jetting direction of the nozzle be in vertically downward direction, or in horizontal position for use to make the ink jetting direction of the nozzle be in horizontal direction.

In the ink jet printer 1 according to the embodiment, there are totally four ink jet heads 2 mounted on the carriage 3 to jet four colors of inks, i.e., black (K), yellow (Y), magenta (M) and cyan (C). The four ink jet heads 2 are arranged in three lines from the view of the sub scanning direction shown in FIG. 1, and two ink jet heads 2 are assigned in the middle line, adjoining to each other in the sub scanning direction.

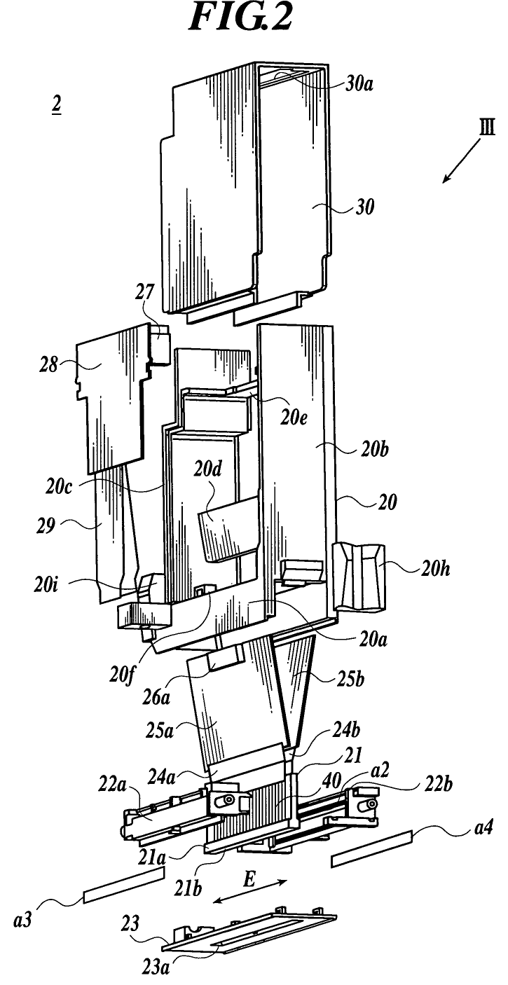

A detail structure of the ink jet head 2 according to the embodiment will hereinafter be described referring to FIGS. 2-6B.

The ink jet head 2 is mounted on the carriage 3. The carriage 3 moves from a home position region B to a maintenance region D in a main scanning direction A along the carriage rail 4. In the recording region C, the main scanning is carried out on the recording medium M by a movement of the carriage 3.

The ink tank 5 is for storing ink which is supplied to the ink jet head 2, and there are four ink tanks 5 mounted corresponding to each of the four ink jet heads 2. The ink supply tube 6 is provided so as to communicate the ink jet head 2 with the ink tank 5. The ink in the ink tank 5 is introduced into the ink jet heads 2 through the ink supply tube 6.

The maintenance unit 7 is for removing foreign objects in the ink jet head 2 by a series of maintenance operations, and for recovering a good condition of the ink jet head 2 for jetting ink. The maintenance unit 7 mounted in the maintenance region D comprises a suction cap 8, a suction pump 9, an ink reservoir 10, a cleaning blade 11, a waste ink tank 12 and the like.

The suction cap 8 communicates with the waste ink tank 12 through the suction pump 9 and is raised when in maintenance operation to cover the nozzle side surface 21b of the ink jet head 2. There are four suction caps 8 mounted so as to cover the nozzle side surface 21b of each of the ink jet heads 2.

The suction pump 9 comprises a cylinder pump or a tube pump which is not shown in the figure, and generates a suction power to suction ink inside of the ink jet head 2 with foreign objects. The suction pump 9 is operated with the nozzle side surface 21b of the ink jet head 2 covered by the suction cap 8 so as to suction the ink inside of the ink jet head 2.

The ink reservoir 10 is for reserving ink pre-jetted by the ink jet head 2 after ink inside the ink jet head 2 was suctioned. The cleaning blade 11 is for removing ink which attaches on the nozzle side surface 21b after pre-jetting ink by the ink jet head 2. The waste ink tank 12 functions to store ink which was suctioned from the ink jet head 2 by an operation of the suction pump 9 or pre-jetted from the ink jet head 2.

The moisture retaining unit 13 is disposed in the home positioning region B, and comprises a moisture retaining cap 14. The moisture retaining cap 14 functions to retain moisture of ink inside the nozzle by covering the nozzle side surface 21b when the ink jet head 2 is on standby. There are four moisture retaining caps 14 provided so as to cover the nozzle side surface 21b of each of the ink jet heads 2.

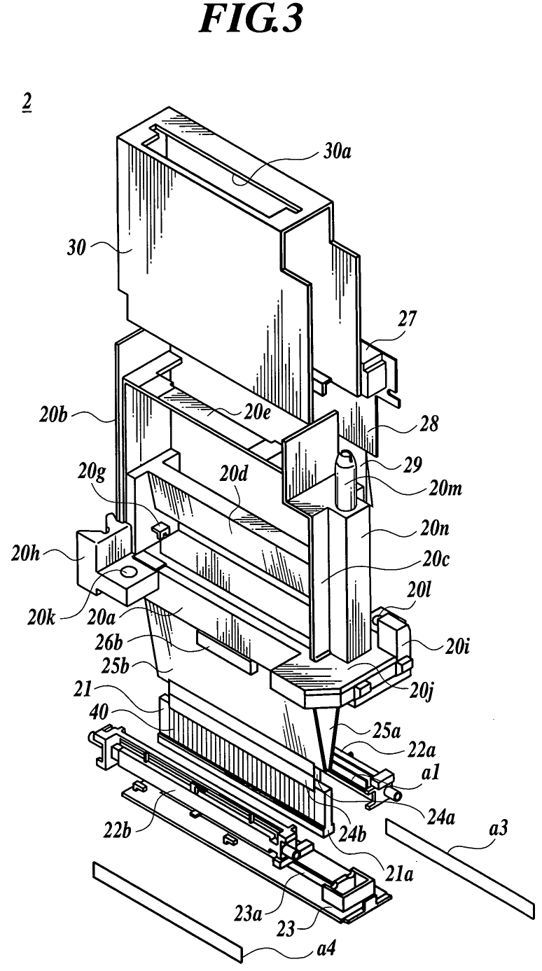

A structure of the ink jet head 2 according to the embodiment will be described referring to FIGS. 2-6B. FIG. 2 is an exploded perspective view of the ink jet head 2 according to the embodiment, and FIG. 3 is an exploded perspective view of the ink jet head shown in FIG. 2 as seen from the back side (the direction of the arrow III in FIG. 2).

The ink jet head 2 according to the embodiment, as shown in FIGS. 2 and 3, comprises the housing frame 20, the nozzle tip 21, two manifolds 22a, 22b, a cap receiving plate 23, a first flexible wiring substrates 24a, 24b, driving circuit substrates 25a, 25b, internal connectors 26a, 26b, an external connector 27, a wiring supporting plate 28, a second flexible wiring substrate 29 and a cover 30.

The housing frame 20 is a frame shape member in the present invention, and is formed as one body by die-casting using aluminum, resin, magnesium, silver or the like. The housing frame 20 comprises a base frame portion 20a for housing the nozzle tip 21, the manifolds 22a, 22b and the cap receiving plate 23, side wall portions 20b, 20c each of which is vertically arranged from each end of a longitudinal direction of the base frame portion 20a, a heat radiation plate 20d and a connector supporting portion 20e which are formed to be crossed over the side wall portions 20b, 20c, and nozzle tip sandwiching portions 20f, 20g each of which are formed inside of the side wall portions 20b, 20c.

The manifolds 22b, 22c, and the cap receiving plate 23 are fixed on the base frame portion 20a with an adhesive. Each of the nozzle tip sandwiching portions 20f, 20g, as hereinafter described in detail, are for sandwiching and holding each end of the back end portion 21c of the nozzle tip 21. The heat radiation plate 20d is for jointing the driving circuit substrates 25a, 25b. The connector supporting portion 20e functions to support the external connector 27.

On a periphery of the base frame portion 20a, three abutment supporting portions 20h, 20i, 20j, and two bolt insertion holes 20k, 201 are provided. The three abutment supporting portions 20h, 20i, 20j abut on three supporting points of the carriage 3 to be supported when the ink jet head 2 is positioned to the carriage 3. After the positioning, the bolt to fix the ink jet head 2 to the carriage 3 is inserted through the bolt insertion holes 20k, 201.

An ink flow path connector 20m which admits ink from outside is formed on the housing frame 20. The ink flow path connector 20m communicates with an ink flow path inside of an ink flow path forming portion 20n which is disposed on the side wall 20c. The ink flow path inside of the ink flow path forming portion 20n is connected to an ink flow path which is formed in each of the manifolds 22a, 22b. The ink is led to the ink flow path of each of the manifolds 22a, 22b through the ink flow path connector 20m and the ink flow path inside of the ink flow path forming portion 20n, and is admitted to each nozzle of the nozzle tip 21.

The nozzle tip 21 according to the present invention is a thin plate shape member comprising a plurality of nozzles at the front end portion 21a. A nozzle with openings for jetting ink is continuously formed in the direction of the arrow E (hereinafter described as a “nozzle arranged direction E”) in FIG. 2 at the front end surface 21b (hereinafter described as a “nozzle side surface”) of the front end portion 21a of the nozzle tip 21. A line of nozzles which is continuously formed in the nozzle arranged direction E is hereinafter described as a “nozzle line”. The ink jet head 2 comprises two nozzle lines.

The nozzle tip 21 has an oblong outer shape in the nozzle arranged direction E, and is mounted on the carriage 3 so as to have the nozzle arranged direction E perpendicular to the main scanning direction A. An electrode (electrode terminal) 40 for connecting each of the first flexible wiring substrate 24a, 24b which will be described below is provided on long side surfaces which are connected to the back end surface of the back end portion 21c of the nozzle tip 21. Each manifold 22a, 22b is attached to each of the long side surfaces of the nozzle tip 21.

A piezoelectric element for generating a pressure to jet ink is built in each nozzle of the nozzle tip 21. The piezoelectric element connected to each nozzle of one nozzle line is driven by a driving circuit mounted on the driving circuit substrate 25a which will be described below. The piezoelectric element connected to each nozzle of the other nozzle line is driven by a driving circuit mounted on the driving circuit substrate 25b which will be described below. Thus, each driving circuit substrates 25a, 25b are connected to each side surfaces of the nozzle tip 21 through each of the first flexible wiring substrates 24a, 24b.

The manifolds 22a, 22b are a member to function as a branch pipe which supplies ink by branching ink led from outside through the ink flow path connector 20m of the housing frame 20 and the ink flow path inside of the ink flow path forming portion 20n to each nozzle of the nozzle tip 21.

Filter mounting portions a1, a2 are provided on the side surface side of the nozzle tip 21 of the manifolds 22a, 22b. A filter a3 is attached on the filter mounting portion a1, and a filter a4 is attached on the filter mounting portion a2. Each of the filters a3, a4 is preferably attached to the filter mounting portions a1, a2, respectively, by thermo-compression or adhesion. The filter mounting portion a1 and a2 are shown in FIG. 3 and FIG. 2, respectively.

The cap receiving plate 23 is a member attached to the lower end of the nozzle tip 21 and the manifolds 22a, 22b. The cap receiving plate 23 contacts with the suction cap 8 or the moisture retaining cap 14. The nozzle side surface 21b is exposed through the opening 23a which is provided in the cap receiving plate 23 when the cap receiving plate 23 is attached to the lower portion of the nozzle tip 21 and the manifolds 22a, 22b.

The first flexible wiring substrates 24a, 24b which are connected to the electrode of the nozzle tip 21 are for electrically connecting the nozzle tip 21 and the driving circuit substrate 25a and so forth. The first flexible wiring substrates 24a, 24b are connected to the driving circuit substrates 25a, 25b which will be described below, and are electrically connected to outside through the internal connectors 26a, 26b, the external connector 27 or the like.

The electrical connection of the driving circuit substrates 25a, 25b to outside is carried out by the internal connectors 26a, 26b, the external connector 27, and the second flexible wiring substrate 29.

The internal connectors 26a, 26b are each mounted on the driving circuit substrates 25a, 25b. An external electrode of the second flexible wiring substrate 29 is connected to the external connector 27. A portion of the second flexible wiring substrate 29 including the external electrode is affixed on the wiring supporting plate 28 to be supported. The end of the second flexible wiring substrate 29 is bifurcated while extending from the wiring supporting plate 28. An internal electrode is formed on each tip of the bifurcated ends of the second flexible wiring substrate 29. The internal electrodes are connected to each of the internal connectors 26a, 26b. When in mounting the ink jet head 2, the external connector 27 is connected to a connector provided on the carriage 3.

When the cover 30 is attached to the housing frame 20, four side surfaces and upper end surface (a surface opposite to the nozzle side surface 21b) of a head housing are formed. An opening for holding connector 30a is formed on an end surface of the cover 30 which forms the upper end surface of the head housing. When the cover 30 is attached to the housing frame 20, the external connector 27 and the wiring supporting plate 28 are held by the opening for holding connector 30a.

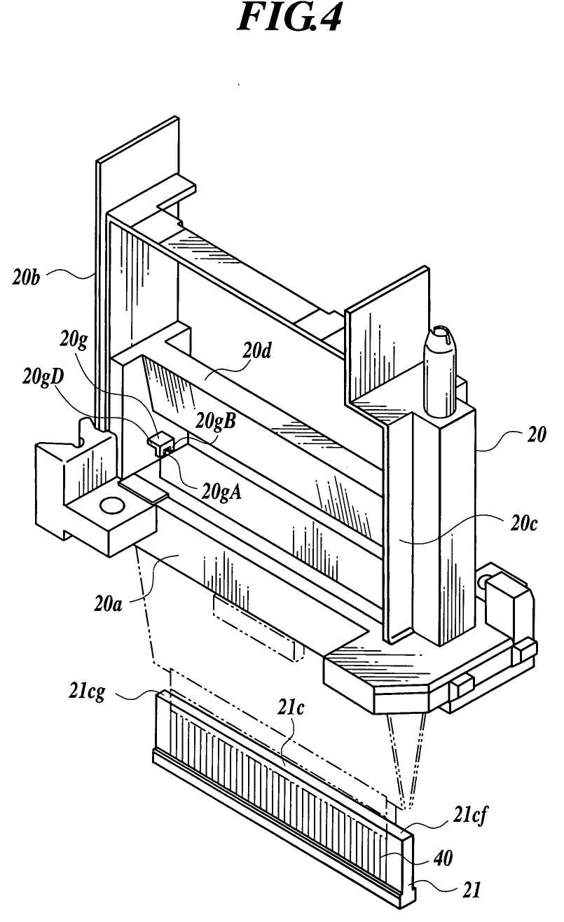

The nozzle tip sandwiching portions 20f, 20g of the housing frame 20 which are the main portion of the present invention will be described referring to FIGS. 4-6B.

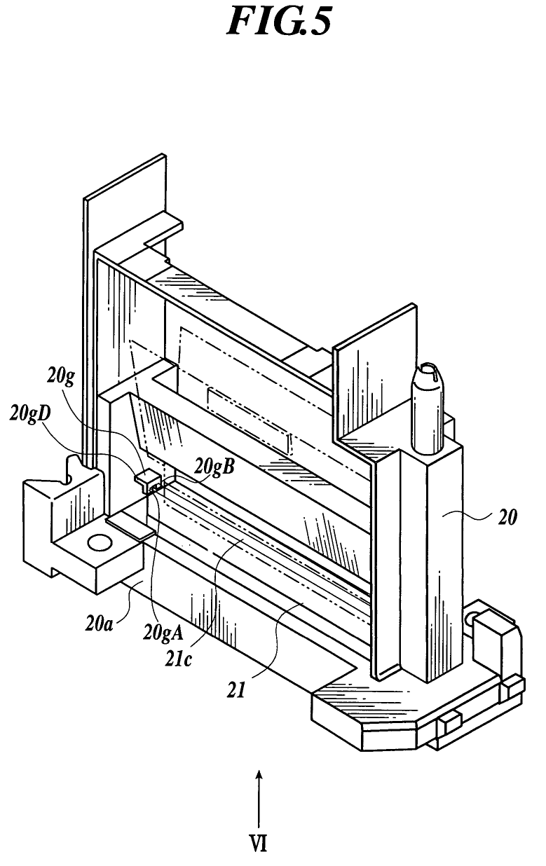

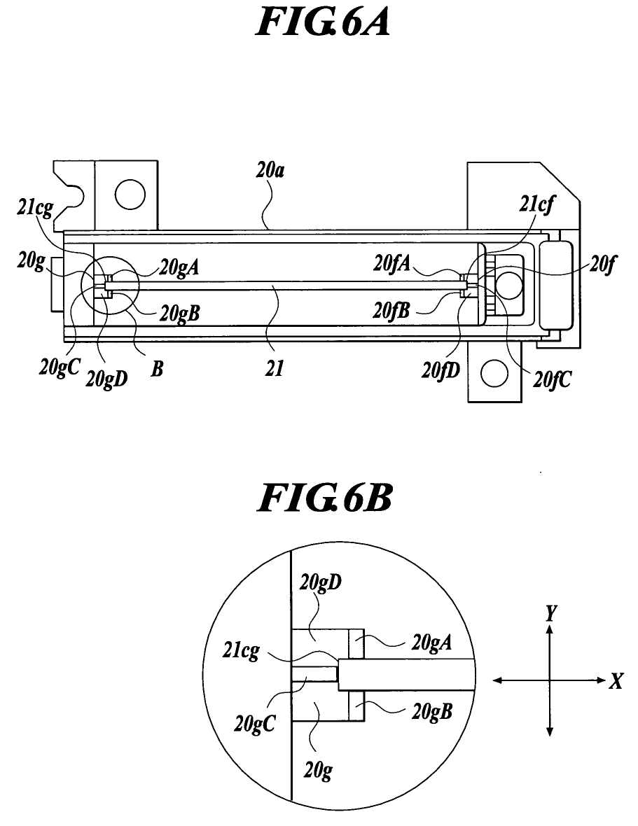

FIG. 4 is an enlarged perspective view showing the housing frame 20 and the nozzle tip 21 before being fixed to the housing frame 20, and FIG. 5 is an enlarged perspective view showing the state in which the nozzle tip 21 is fixed to the housing frame 20. FIG. 6A is a view of the housing frame 20 and the nozzle tip 21 shown in FIG. 5 seen from the direction of the arrow VI, and FIG. 6B is an enlarged view of the B portion in FIG. 6A.

The nozzle tip sandwiching portions 20f, 20g mean a first protrusion member and a second protrusion member provided inside of each of the side wall portions 20b, 20c of the housing frame 20. The nozzle tip sandwiching portions 20f, 20g function, as described above, to sandwich and hold each end of the back end portion 21c of the nozzle tip 21. In the present invention, the back end portion 21c of the nozzle tip 21 means an end portion which is opposite to the nozzle side surface 21b of the nozzle tip 21, and comprises a back end surface and a portion of the four side surfaces connected to and adjacent to the back end surface.

As shown in FIGS. 4 and 5, a plurality of protrusions (20gA, 20gB and so forth) is provided on a substantially rectangular-shaped flat plate portion 20gD downwardly to form the nozzle tip sandwiching portion 20g. The nozzle tip sandwiching portion 20f which is not shown in FIGS. 4 and 5 also has the structure same as the nozzle tip sandwiching portion 20g. In the embodiment, the housing frame 20 is formed by die-casting. A flat plate portion and a protrusion of the nozzle tip sandwiching portions 20f, 20g are formed by carrying out cutting process on a substantially cuboid-shaped member which is formed inside of each of the side wall portions 20b, 20c of the housing frame 20.

The protrusions group shown in FIGS. 4 and 5 which is provided on the flat plate portion 20gD of the nozzle tip sandwiching portion 20g downwardly functions to sandwich and hold the back end portion 21c of the nozzle tip 21. The protrusions group will be explained below referring to FIGS. 6A and 6B.

The nozzle tip sandwiching portion 20f as shown in FIG. 6A comprises a long side sandwiching protrusion pair 20fA, 20fB which are opposing each other so as to sandwich and hold one end 21cf of the long side surfaces which are connected to the back end surface of the back end portion 21c of the nozzle tip 21. The nozzle tip sandwiching portion 20g as shown in FIGS. 4-6B comprises a long side sandwiching protrusion pair 20gA, 20gB which is opposing each other so as to sandwich and hold the other end 21cg of the long side surfaces which are connected to the back end surface of the back end portion 21c of the nozzle tip 21. The long side sandwiching protrusion pairs 20fA, 20fB and 20gA, 20gB mean a first protrusion pair in the present invention.

Any of the long side sandwiching protrusion pairs 20fA, 20fB and 20gA, 20gB sandwich the portion of the long side surfaces which are connected to the back end surface of the back end portion 21c of the nozzle tip 21, excluding a portion on which an electrode (electrode terminal) 40 is provided.

The nozzle tip sandwiching portions 20f, 20g as shown in FIGS. 6A and 6B also comprises a short side sandwiching protrusion pair 20fC, 20gC which is opposing each other so as to sandwich and hold short side surfaces which are connected to the back end surface of the back end portion 21c of the nozzle tip 21. The short side sandwiching protrusion pair 20fC, 20gC means a second protrusion pair in the present invention.

The one end 21cf of the long side surfaces which are connected to the back end surface of the back end portion 21c of the nozzle tip 21 is sandwiched and held by the long side sandwiching protrusion pair 20fA, 20fB. The other end 21cg of the long side surfaces which are connected to the back end surface of the back end portion 21c of the nozzle tip 21 is sandwiched and held by the long side sandwiching protrusion pair 20gA, 20gB. Thus, the relative position of the nozzle tip 21 to the housing frame 20 in the Y direction in FIG. 6B can be determined.

The short side surfaces which are connected to the back end surface of the back end portion 21c of the nozzle tip 21 are sandwiched and held by the short side sandwiching protrusion pair 20fC, 20gC. Thus, the relative position of the nozzle tip 21 to the housing frame 20 in the X direction in FIG. 6B can be determined.

That is, the back end portion 21c of the nozzle tip 21 is sandwiched and held by the long side sandwiching protrusion pairs 20fA, 20fB and 20gA, 20gB and the short side sandwiching protrusion pair 20fC, 20gC which are provided on the nozzle tip sandwiching portions 20f, 20g of the housing frame 20. Thus, the relative position in a horizontal direction of the nozzle tip 21 to the housing frame 20 can be determined (refer to FIGS. 5, 6A and 6B).

Further, the substantially rectangular-shaped flat plate portions 20fD, 20gD which form the nozzle tip sandwiching portions 20f, 20g are for determining the relative position in a vertical direction of the nozzle tip 21 to the housing frame 20. The flat plate portions 20fD, 20gD will be explained below.

The flat plate portion 20gD of the nozzle tip sandwiching portion 20g, as shown in FIG. 5, functions to make the back end surface of the back end portion 21c of the nozzle tip 21 abut on the nozzle tip sandwiching portion 20g. The flat plate portion 20fD of the nozzle tip sandwiching portion 20f which is not shown in FIGS. 4 and 5 also functions to make the back end surface of the back end portion 21c of the nozzle tip 21 abut on the nozzle tip sandwiching portion 20f. Each of the flat plate portions 20fD, 20gD means an abutment portion in the present invention.

The back end surface of the back end portion 21c of the nozzle tip 21 abuts on the flat plate portions 20fD, 20gD of the nozzle tip sandwiching portions 20f, 20g. Thus, the relative position in a vertical direction of the nozzle tip 21 to the housing frame 20 can be determined (refer to FIGS. 5, 6A and 6B).

In the ink jet head 2 according to the embodiment, the long side surfaces adjacent to the back end surface of the back end portion 21c of the nozzle tip 21 are sandwiched by each of the long side sandwiching protrusion pairs 20fA, 20fB and 20gA, 20gB provided on the nozzle tip sandwiching portions 20f, 20g, and the short side surfaces adjacent to the back end surface of the nozzle tip 21c of the nozzle tip 21 are sandwiched by the short side sandwiching protrusion pair 20fC, 20gC. Thus the nozzle tip 21 can be positioned properly to the housing frame 20 in a horizontal direction.

In the ink jet head 2 according to the embodiment, since the long side sandwiching protrusion pairs 20fA, 20fB and 20gA, 20gB provided on the nozzle tip sandwiching portions 20f, 20g abut in the vicinity of each end of the long side surfaces excluding a portion on which the electrode terminal is disposed to sandwich the nozzle tip 21, the nozzle tip 21 can be positioned to the housing frame 20 more properly, and this allows other members to be connected to the electrode terminal.

In the ink jet head 2 according to the embodiment, since the back end surface of the back end portion 21c of the nozzle tip 21 is abutted on the flat plate portions 20fD, 20gD of the nozzle tip sandwiching portions 20f, 20g of the nozzle tip 21, the nozzle tip 21 can be positioned properly to the housing frame 20 in a vertical direction.

In the ink jet head 2 according to the embodiment, since the nozzle tip 21 can be positioned properly only by forming a specific protrusions group and a flat portion by carrying out cutting process on a portion of the housing frame 20, it is unnecessary to carry out cutting process in wide area on the housing frame as the earlier technique. Accordingly, the time and cost for cutting process are extremely reduced.

In the ink jet printer 1 according to the embodiment, since the ink jet head 2 is mounted to the carriage 3 in a state pre-positioned, the relative position relation of the nozzle tip 21 to the carriage 3 can be fixed. Thus, displacement of the ink jetting position can be prevented and an image with a high accuracy can be formed.

Second Embodiment

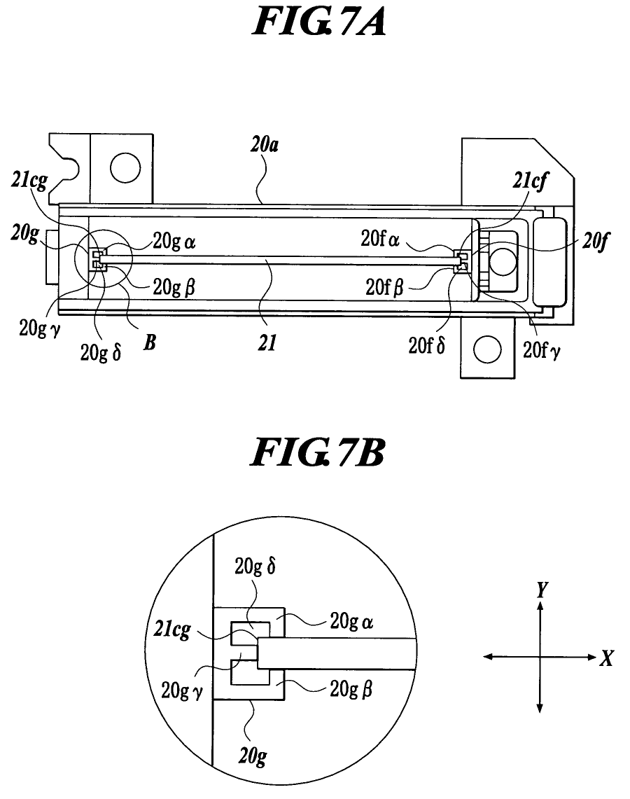

The ink jet printer according to the second embodiment will be described referring to FIGS. 7A and 7B. In the ink jet printer 1 according to the present embodiment, only the structure of the nozzle tip sandwiching portions 20f, 20g of the housing frame 20 of the ink jet head 2 is changed in comparison with the ink jet printer 1 according to the first embodiment, and other structures are substantially the same as those of the first embodiment. In the following explanation, the same references are attached to structural members, elements or the like corresponding to the ink jet printer 1 in the first embodiment.

FIG. 7A is a view showing the housing frame 20 and the nozzle tip 21 fixed to the housing frame seen from below, like FIG. 6B. FIG. 7B is an enlarged view of the B portion in FIG. 7A.

In the embodiment, the nozzle tip sandwiching portion 20g comprises a flat plate portion 20gδ and a particular shape of protrusions (20gα, 20gβ and so forth) which are provided on the flat plate portion 20gδ downwardly. In the embodiment, the housing frame 20 is formed by die-casting. A flat plate portion and a protrusion of the nozzle tip sandwiching portions 20f, 20g are formed by carrying out cutting process on a substantially cuboid-shaped member which is formed inside of each of the side wall portions 20b, 20c of the housing frame 20.

The nozzle tip sandwiching portion 20g in the embodiment, as shown in FIGS. 7A and 7B, comprises a long side sandwiching protrusion pair 20gα, 20gβ which is opposing each other so as to sandwich and hold the one end 21cg of the long side surfaces which are connected to the back end surface of the back end portion 21c of the nozzle tip 21. The nozzle tip sandwiching portion 20f, as shown in FIG. 7A, also comprises a long side sandwiching protrusion pair 20fα, 20fβ which is opposing each other so as to sandwich and hold the other end 21cf of the long side surfaces which are connected to the back end surface of the back end portion 21c of the nozzle tip 21.

The long side sandwiching protrusion pairs 20fα, 20fβ and 20gα, 20gβ mean a first protrusion pair in the present invention.

Any of the long side sandwiching protrusion pairs 20fα, 20fβ and 20gα, 20gβ sandwiches the portion of the long side surfaces which are connected to the back end surface of the back end portion 21c of the nozzle tip 21, excluding a portion on which an electrode (electrode terminal) 40 is provided.

The nozzle tip sandwiching portion 20f, 20g, as shown in FIGS. 7A and 7B, comprises a short side sandwiching protrusion pair 20fγ, 20gγ which is opposing each other to sandwich and hold the short side surfaces which are connected to the back end surface of the back end portion 21c of the nozzle tip 21.

The short side sandwiching protrusion pair 20fγ, 20gγ means a second protrusion pair in the present invention.

In the embodiment, cutting process is carried out so as to link the long side sandwiching protrusion pair 20fα, 20fβ to the short side sandwiching protrusion pair 20fγ, and to link the long side sandwiching protrusion pair 20gα, 20gβ to the short side sandwiching protrusion pair 20gγ as is apparent in FIGS. 7A and 7B.

The one end 21cf of the long side surfaces which are connected to the back end surface of the back end portion 21c of the nozzle tip 21 is sandwiched and held by the long side sandwiching protrusion pair 20fα, 20fβ. The other end 21cg of the long side surfaces which are connected to the back end surface of the back end portion 21c of the nozzle tip 21 is sandwiched and held by the long side sandwiching protrusion pair 20gα, 20gβ. Thus, the relative position of the nozzle tip 21 to the housing frame 20 in the Y direction in FIG. 7B can be determined.

The short side surfaces which are connected to the back end surface of the back end portion 21c of the nozzle tip 21 are sandwiched and held by the short side sandwiching protrusion pair 20fγ, 20gγ. Thus, the relative position of the nozzle tip 21 to the housing frame 20 in the X direction in FIG. 7B can be determined.

That is, the back end portion 21c of the nozzle tip 21 is sandwiched and held by the long side sandwiching protrusion pairs 20fα, 20fβ and 20gα, 20gβ and the short side sandwiching protrusion pair 20fγ, 20gγ which are provided on the nozzle tip sandwiching portions 20f, 20g of the housing frame 20. Thus, the relative position in a horizontal direction of the nozzle tip 21 to the housing frame 20 can be determined (refer to FIGS. 7A and 7B).

The substantially rectangular-shaped flat plate portions 20fδ, 20fδ which form the nozzle tip sandwiching portions 20f, 20g are for determining the relative position in a vertical direction of the nozzle tip 21 to the housing frame 20. The flat plate portion 20gδ of the nozzle tip sandwiching portion 20g functions to make the back end surface of the back end portion 21c of the nozzle tip 21 abut on the nozzle tip sandwiching portion 20g. The flat plate portion 20fδ of the nozzle tip sandwiching portion 20f also functions to make the back end surface of the back end portion 21c of the nozzle tip 21 abut on the nozzle tip sandwiching portion 20f. The flat plate portions 20fδ, 20gδ mean an abutment portion in the present invention.

The back end surface of the back end portion 21c of the nozzle tip 21 abuts on the flat plate portions 20fδ, 20gδ of the nozzle tip sandwiching portions 20f, 20g. Thus, the relative position in a vertical direction of the nozzle tip 21 to the housing frame 20 can be determined (refer to FIGS. 7A and 7B).

In the ink jet head according to the embodiment, the long side surfaces adjacent to the back end surface of the back end portion 21c of the nozzle tip 21 are sandwiched by each of the long side sandwiching protrusion pairs 20fα, 20fβ and 20gα, 20gβ provided on the nozzle tip sandwiching portions 20f, 20g, and the short side surfaces adjacent to the back end surface of the nozzle tip 21c of the nozzle tip 21 by the short side sandwiching protrusion pair 20fγ, 20gγ. Thus the nozzle tip 21 can be positioned properly to the housing frame 20 in a horizontal direction.

In the ink jet head according to the embodiment, since the long side sandwiching protrusion pairs 20fα, 20fβ and 20gα, 20gβ provided on the nozzle tip sandwiching portions 20f, 20g abut in the vicinity of each end of the long side surfaces excluding a portion on which the electrode terminal is disposed to sandwich the nozzle tip 21, the nozzle tip 21 can be positioned to the housing frame 20 more properly, and this allows other members to be connected to the electrode terminal.

In the ink jet head according to the embodiment, since the back end surface of the back end portion 21c of the nozzle tip 21 is abutted on the flat plate portions 20fδ, 20gδ of the nozzle tip sandwiching portions 20f, 20g of the nozzle tip 21, the nozzle tip 21 can be positioned properly to the housing frame 20 in a vertical direction.

In the ink jet head according to the embodiment, since the nozzle tip 21 can be positioned properly only by forming a specific protrusions group and a flat portion by carrying out cutting process on a portion of the housing frame 20, it is unnecessary to carry out cutting process for fine adjustment of the shape of the surface as the earlier technique. Accordingly, the time and cost for cutting process are extremely reduced.

In the ink jet printer according to the embodiment, since the ink jet head 2 is mounted to the carriage 3 in a state pre-positioned, the relative position relation of the nozzle tip 21 to the carriage 3 can be fixed. Thus, displacement of the ink jetting position can be prevented and an image with a high accuracy can be formed.

In the embodiment, the nozzle tip sandwiching portions 20f, 20g comprising the long side sandwiching protrusion pairs (first protrusion pairs), the short side sandwiching protrusion pair (second protrusion pair) and the flat plate portions (abutment portion) of the shape as shown in FIGS. 6B and 7B are formed by carrying out cutting process on a portion of the housing frame 2. A shape of the first protrusion pairs, the second protrusion pair and the abutment portion are not limited to the shape in the embodiments.

That is, the first protrusion pair may be any shape if the first protrusion pair is opposing each other so as to sandwich and hold the long side surfaces which are connected to the back end surface of the back end portion 21c of the nozzle tip 21. Also, the second protrusion pair may be any shape if the second protrusion pair is opposing each other so as to sandwich and hold the short side surfaces which are connected to the back end surface of the back end portion 21c of the nozzle tip 21. Further, the abutment portion may be any form if the abutment portion is to make the back end surface of the back end portion 21c of the nozzle tip 21 abut on the abutment portion.

The entire disclosure of Japanese Patent Application No. Tokugan 2002-256055 which was filed on Aug. 30, 2002, including specification, claims, drawings and summary are incorporated herein by reference in its entirety.

What is claimed is:

1. An ink jet head comprising:
a nozzle tip comprising a front end surface in which a nozzle for jetting ink is provided, and four side surfaces adjacent to a back end surface which is opposite to the nozzle; and
a frame shape member on which the nozzle tip is mounted, the frame shape member comprising a first protrusion pair which abuts on one pair of facing sides of the four side surfaces to sandwich the nozzle tip, and a second protrusion pair which abuts on the other pair of facing sides of the four side surfaces to sandwich the nozzle tip.

2. The ink jet head of claim 1, wherein the nozzle tip comprises an electrode terminal on a central portion of the one pair of facing sides, and the first protrusion pair abuts on a portion of the one pair of facing sides on which no electrode terminal is provided to sandwich the nozzle tip.

3. The ink jet head of claim 1, wherein the frame shape member comprises an abutment portion on which the back end surface of the nozzle tip abuts.

4. The ink jet head of claim 1, wherein the frame shape member comprises a first protrusion member and a second protrusion member on inner walls of both ends of the frame shape member, respectively, so as to face each other, the first protrusion member comprising the first protrusion pair and one protrusion of the second protrusion pair, the second protrusion member comprising the first protrusion pair and the other protrusion of the second protrusion pair.

5. The ink jet head of claim 4, wherein each of the first protrusion member and the second protrusion member further comprises an abutment portion on which the back end surface of the nozzle tip abuts.

6. The ink jet head of claim 5, wherein the first protrusion pair is arranged on the abutment portion perpendicularly.

7. The ink jet head of claim 5, wherein the second protrusion pair is arranged on the abutment portion perpendicularly.

8. The ink jet head of claim 1, wherein the frame shape member is made of at least one selected from aluminum, resin, magnesium and silver.

9. The ink jet head of claim 1, wherein the frame shape member is formed as one body by die-casting.

10. The ink jet head of claim 9, wherein the first protrusion pair and the second protrusion pair are formed by cutting process.

11. The ink jet head of claim 1, wherein the nozzle tip has a thin plate shape.

12. The ink jet head of claim 1, wherein the back end surface of the nozzle tip has a uniform width.

13. The ink jet head of claim 1, wherein a width of the back end surface of the nozzle tip is smaller than a width of the front end surface.

14. The ink jet head of claim 1, wherein a piezoelectric element of shear mode type is built in the ink jet head.

15. An ink jet printer comprising:
an ink jet head which comprises a nozzle tip comprising a front end surface in which a nozzle for jetting ink is provided and four side surfaces adjacent to a back end surface which is opposite to the nozzle, and a frame shape member comprising a first protrusion pair which abuts on one pair of facing sides of the four side surfaces to sandwich the nozzle tip and a second protrusion pair which abuts on the other pair of facing sides of the four side surfaces to sandwich the nozzle tip, for mounting the nozzle tip; and
a carriage on which the ink jet head is mounted in a state pre-positioned.

16. The ink jet printer of claim 15, wherein the nozzle tip comprises an electrode terminal on a central portion of the one pair of facing sides, and the first protrusion pair abuts on a portion of the one pair of facing side on which no electrode terminal is provided to sandwich the nozzle tip.

17. The ink jet printer of claim 15, wherein the frame shape member comprises an abutment portion on which the back end surface of the nozzle tip abuts.

18. The ink jet printer of claim 15, wherein the frame shape member comprises a first protrusion member and a second protrusion member on inner walls of both ends of the frame shape member, respectively, so as to face each other, the first protrusion member comprising the first protrusion pair and one protrusion of the second protrusion pair, the second protrusion member comprising the first protrusion pair and the other protrusion of the second protrusion pair.

19. The ink jet printer of claim 18, wherein each of the first protrusion member and the second protrusion member further comprises an abutment portion on which the back end surface of the nozzle tip abuts.

20. The ink jet printer of claim 19, wherein the first protrusion pair is arranged on the abutment portion perpendicularly.

21. The ink jet printer of claim 19, wherein the second protrusion pair is arranged on the abutment portion perpendicularly.

22. The ink jet printer of claim 15, wherein the frame shape member is made of at least one selected from aluminum, resin, magnesium and silver.

23. The ink jet printer of claim 15, wherein the frame shape member is formed as one body by die-casting.

24. The ink jet printer of claim 23, the first protrusion pair and the second protrusion pair are formed by cutting process.

25. The ink jet printer of claim 15, wherein the nozzle tip has a thin plate shape.

26. The ink jet printer of claim 15, wherein the back end surface of the nozzle tip has a uniform width.

27. The ink jet printer of claim 15, wherein a width of the back end surface of the nozzle tip is smaller than a width of the front end surface.

28. The ink jet printer of claim 15, wherein a piezoelectric element of shear mode type is built in the ink jet head.
